(19) United States
(12) Patent Application Publication
(10) Pub. No.: US 2004/0238555 A1
(43) Pub. Date: Dec. 2, 2004

(54) Vending machine that delivers made-to-order food items

(76) Inventor: Charley M. Parks, Austin, TX (US)

Correspondence Address: BOOTH & WRIGHT LLP, P O BOX 50010, AUSTIN, TX, 78763-0010, US

(21) Appl. No.: 10/855,018

(22) Filed: May 27, 2004

Related U.S. Application Data
(60) Provisional application No. 60/473,604, filed on May 27, 2003.

(51) Int. Cl. G07F 11/00

(52) U.S. Cl. 221/80; 221/76; 221/81

(57) ABSTRACT

The vending machine disclosed automatically assembles and delivers a made-to-order food item such as a submarine sandwich, salad, taco, or sandwich wrap in response to a customer order. The machine includes a conveyer that produces relative motion between a food item and ingredient dispensing stations that dispense customer-selected ingredients, including condiments, dressings, seasonings, sliced meats and cheeses, vegetables, and soft sandwich spreads. The machine may include an oven that bakes a portion of the food item, and may include a computer with a network interface.

### CROSS REFERENCE TO RELATED APPLICATIONS

This application claims the benefits of the earlier filed U.S. Provisional Application Serial No. 60/473,604, filed 27 May 2003 (27.05.2003), which is incorporated by reference for all purposes into this specification.

### BACKGROUND OF THE INVENTION

1. Field of the Invention

The present invention generally relates to the field of vending machines, and more specifically to vending machines specialized for the delivery of food products.

2. Description of the Related Art

Vending machines have been in use for over 100 years. They provide a convenient mechanism for a consumer to make a purchase at any time, without the vendor having to staff a retail location round-the-clock. For the most part, such vending machines deliver a pre-made, pre-packaged product to the consumer with limited opportunity for customization of the purchase.

Submarine sandwich shops serve a growing segment of the fast food industry. Over 20,000 locations are known to be open at the time of this writing, with over 1,000 new shops opening every year. Such shops, by their nature, sell a limited menu into an increasingly competitive market. A typical establishment might sell sandwiches and salads made to the customer's order, along with an assortment of accoutrements such as chips, soft drinks, and packaged cookies. The demand for the shop's product is intermittent, with a large peak at lunch, and other smaller peaks that may be a function of the location, e.g., stores located near movie theaters would experience a rush of business when patrons leave the theater. This uneven demand places a burden on sandwich shop owners, who must size and schedule their labor force to handle the peaks without overspending on labor during their slow times.

A vending machine that can assemble sandwiches, wraps, salads, and other food items in response to a customer order would provide a more efficient solution to this problem. Customers would still receive a food item customized to their preferences, but the proprietor's labor costs are virtually eliminated.

### SUMMARY OF THE INVENTION

The present invention is a vending machine apparatus that automatically assembles a made-to-order food item such as a submarine sandwich, salad, taco, or sandwich wrap in response to a customer order, along with methods for making and using the machine and food item assembly system. The present invention includes a conveyer that produces relative motion between a food item and ingredient dispensing stations that include at least a first, second, and third dispensing station that dispense first, second, and third customer-selected ingredients, respectively. Dispensed ingredients may include one or more condiments, dressings, seasonings, one or more slices of meat, one or more slices of cheese, one or more types of diced vegetables, and one or more soft sandwich spreads. The vending machine may also include an oven that bakes one or more portions of the food item. A computer that controls the conveyer and the ingredient dispensing stations may be included, and the computer may also interface to a network.

### DESCRIPTION OF THE DRAWINGS

The attached drawings help illustrate specific features of the invention and to further aid in understanding the invention. The following is a brief description of those drawings:

FIG. 1 shows a perspective view of the front of the vending machine according to one embodiment, including its user interface components.

FIG. 2 is a perspective view of one embodiment of the machine with the front removed to show the arrangement of the vending machine's internal components and systems.

FIG. 3 is an exploded view of the internal components and systems of the vending machine, according to one embodiment.

FIG. 4 shows the baking section 114.

FIG. 5 shows the bun storage module 116.

FIG. 6 is a perspective view of the upper assembly section 118, according to one embodiment of the sandwich vending machine 100.

FIG. 7 is a perspective view of the upper assembly section 118, shown from the direction opposite that shown in FIG. 6.

FIG. 8 shows one embodiment of a condiment bin 604 adapted for use in the upper assembly section 118 of the sandwich vending machine 100.

FIG. 9 shows an alternate embodiment of condiment bin 604 adapted for use in the upper assembly section 118 of the sandwich vending machine 100.

FIG. 10 shows a partial cutaway perspective view of one embodiment of the sliced item station 610.

FIGS. 11A, 11B, and 11C show the side view, “stack side” view, and “slice side” view, respectively, of the wedge 650.

FIG. 12 shows a typical conveyer wash station 670.

FIG. 13 shows a set of extruded product bins 614, one of which is shown in a cutaway view.

FIG. 14 shows a perspective view of the lower assembly section 120 of the sandwich vending machine 100, according to one embodiment.

FIG. 15 shows a view of the lower assembly section 120 of the sandwich vending machine 100, from the opposite perspective of that shown in FIG. 14.

FIG. 16A shows a perspective view of one embodiment of a large diced item bin 680 adapted for use in the lower assembly section 120 of the sandwich vending machine 100.

FIG. 16B is a perspective view of the rotatable bladed dispensing mechanism in the snap-on lid of the large diced item bin shown in FIG. 16A.

FIG. 17A is a perspective view of one embodiment of a small diced item bin 690 adapted for use in the lower assembly section 120 of the sandwich vending machine 100.

FIG. 17B is a perspective view of the FIG. 17A small diced item bin, with its lid dispensing components shown as an exploded view.

FIGS. 17C-F are side and top views of the small diced item bin lid components.

FIG. 18 is a cutaway perspective view of one embodiment of a dressing bin 700 adapted for use in the lower assembly section 120 of the sandwich vending machine 100.

FIG. 19 shows one embodiment of a seasoning bin 710 adapted for use in the lower assembly section 120 of the sandwich vending machine 100.

FIG. 20 is a block diagram showing the major control functions and interfaces of the submarine sandwich vending machine 100.

### DETAILED DESCRIPTION OF THE INVENTION

This invention discloses a vending machine that assembles a sandwich, salad, or other food item in response to a customer order, using the types and quantities of ingredients specified by the customer. This disclosure describes numerous specific details that include mechanisms for food and condiment dispensing and sandwich assembly, along with other details such as specific sandwiches, cooking appliances, and cleaning techniques. One skilled in the art will appreciate that one may practice this invention without these specific details. In addition, those skilled in the art will understand that while this disclosure describes the invention embodied in a vending machine that makes and dispenses fresh sandwiches, other food making and dispensing embodiments, including embodiments that make and dispense salads, wraps, desserts, snacks, and the like will not depart from the present invention.

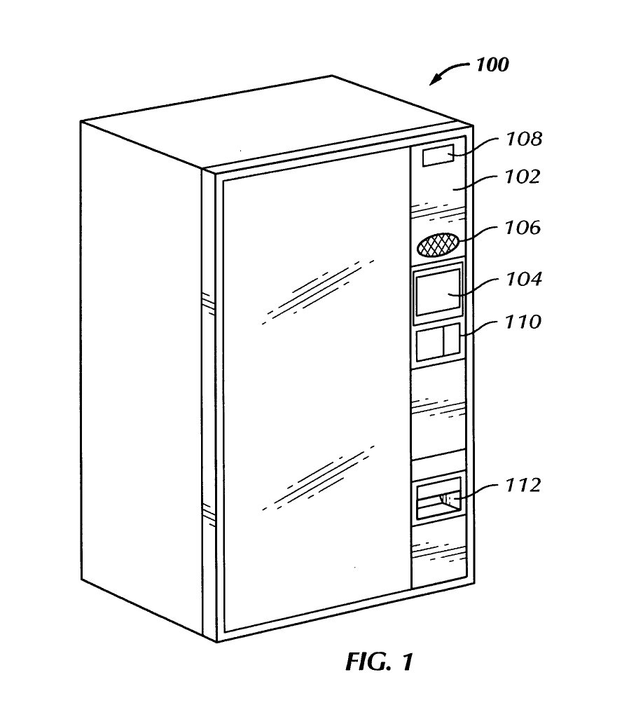

FIG. 1 depicts a submarine sandwich vending machine 100, according to one embodiment of the present invention. The customer interacts with the vending machine 100 via a menu-driven user interface on the front panel 102, which includes a touch-sensitive CRT 104, a speaker 106, a proximity detector 108, and a payment acceptance mechanism 110 that may include any or all of the following: a credit card acceptor, a bill acceptor, a coin acceptor, and a coin return. Those skilled in the art will recognize that while the embodiment shown in FIG. 1 includes a touch-sensitive CRT 104, any display system that enables user interaction, such as a CRT or LCD display screen with multifunction buttons, a keypad, or a keyboard may be used without departing from the present invention. In FIG. 1, the CRT 104 displays menus that facilitate the customers' description of the sandwich they wish to purchase. The proximity detector 108 initiates a visual and/or aural commercial or instructional message when a potential customer passes within a specified distance from the front of the machine. The machine dispenses a sandwich freshly made according to the customer's specifications into the retrieval bin 112.

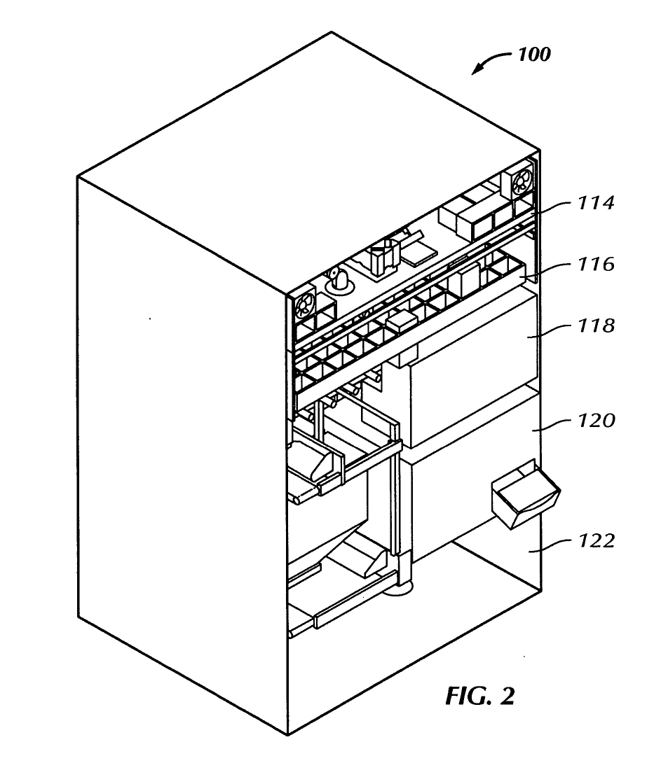

FIG. 2 is a perspective view of the sandwich vending machine 100, with the front removed to show some of the internal components and systems and their arrangement in the machine. FIG. 2 shows the position of the baking section 114, the bun storage module 116, the upper assembly section 118, which is refrigerated, and the lower assembly section 120, which is also refrigerated. The lowest section 122 of the vending machine is dedicated to mechanical support functions, including a refrigerator compressor, a water heater/filtration unit, an air compressor, and a pressurized air storage tank.

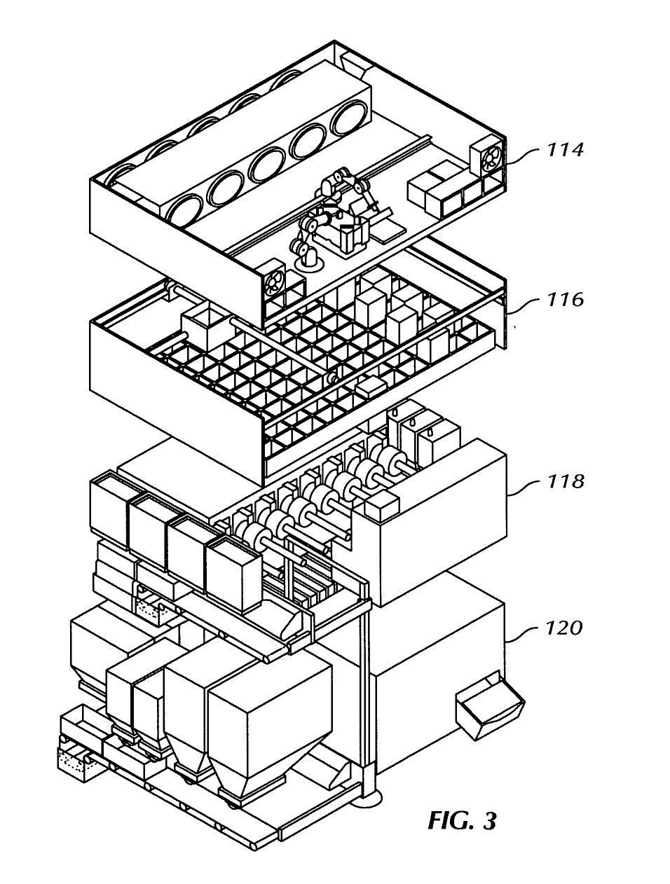

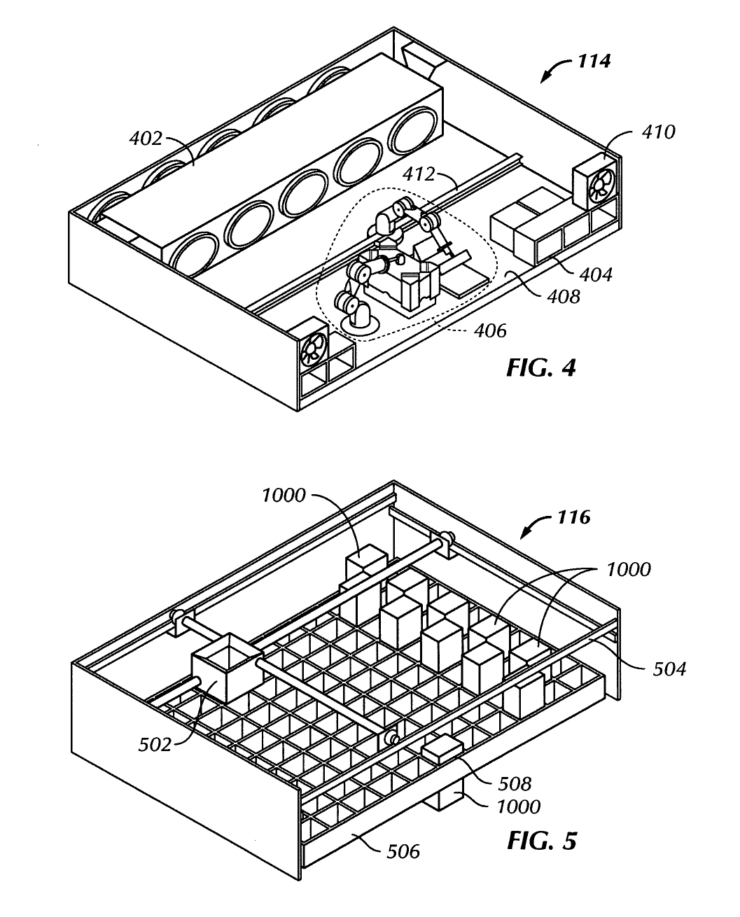

FIG. 3 is an exploded view showing the major sandwich-making components of the sandwich vending machine 100: the baking section 114, the bun storage module 116, the upper assembly section 118, and the lower assembly section 120. Each section is shown and described in further detail in FIGS. 4-20 and the accompanying text below.

FIG. 4 shows the baking section 114. The baking section 114 includes ovens 402, temporary box storage 404, and a robotic box and bun manipulator mechanism 406 that moves along rod 412. The bottom 408 of the baking section 114 is insulated to protect the other sections from heat generated by the ovens 402, and fans 410 disperse both the heat and the aroma of baking rolls outside the vending machine 100.

FIG. 5 shows the bun storage module 116. The bun storage module 116 includes a bun bin 506 that holds both freshly baked and parbaked sandwich rolls stored in individual boxes 1000, along with a guide 502 that slides along a set of guide rods 504 positioned above and parallel to the bun bin 506. Boxes 1000 stored in the bun bin 506 that contain parbaked rolls are destined for the baking section 114. A baking cycle begins when the guide 502 aligns itself above a position in the bun bin 506 where a box 1000 containing a parbaked roll is stored. A manipulator extends down from the guide 502 and pulls the box containing the parbaked roll into the guide 502. The guide 502, now holding the box containing the parbaked roll, moves along guide rods 504 to position the box underneath the robotic box and bun manipulator mechanism 406. The manipulator mechanism 406 retrieves the box from the guide 502, opens the box, removes the parbaked bun inside, and places the bun inside one of the ovens 402. The manipulator mechanism 406 also stores the empty box in temporary box storage locations 404. This process repeats until as many buns are placed into the ovens as desired. After the buns have browned, the manipulator mechanism 406 retrieves the freshly baked buns from the ovens 402, replaces them into their boxes 1000, and drops them into guide 502, which moves along guide rods 504 to align the box containing a freshly browned bun above a selected location in bun bin 506. Once aligned, the robotic manipulator deposits the box 1000 containing the browned sandwich roll into the bun bin 506.

As shown in FIG. 5, there is one position 508 in bun bin 506 that does not hold a box containing either a parbaked roll or a browned roll, but instead, allows boxes 1000 to drop through to the upper assembly section 118. When a sandwich is ordered, the guide 502 moves to a position above a box containing a roll of the proper type that has been browned and stored in the bun bin 506. The guide manipulator captures the box, moves it to a position above the drop-through position 508, and drops the box to the upper assembly section 118.

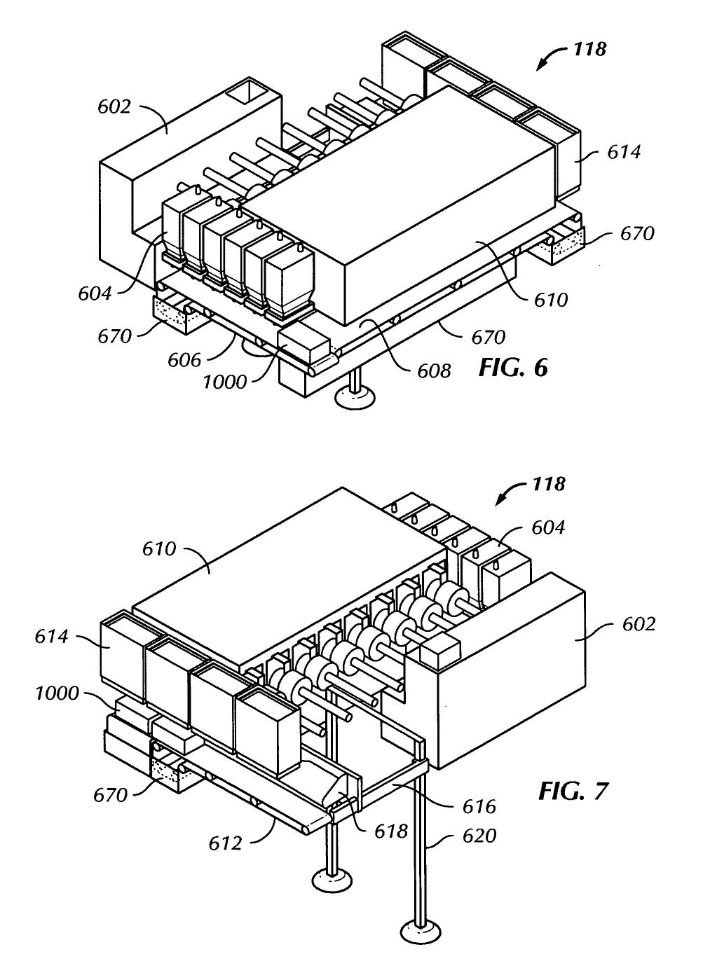

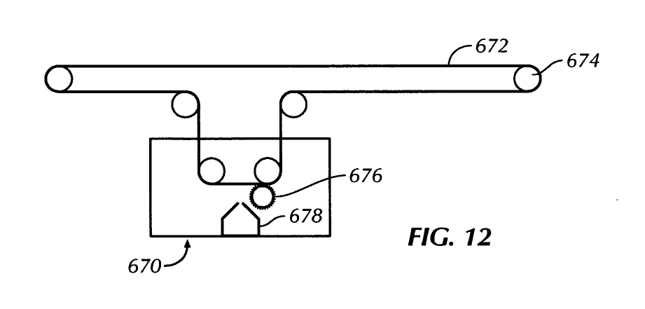

FIG. 6 shows a perspective view of the upper assembly section 118, according to one embodiment of the sandwich vending machine 100. In the upper assembly section 118, as described above, boxes 1000 containing browned rolls drop from the bun storage module 116 above into the slicing station 602, where the boxes are opened and the buns are sliced in half lengthwise. The bun halves are then placed into the open box halves 1000, which are placed onto conveyer 606. Thereafter, the boxed bun halves 1000 pass directly under a series of condiment bins 604, which dispense condiments such as mustard, mayonnaise, salad dressing, etc. onto the sliced side of the bun as it passes underneath. When the boxed bun halves 1000 reach the end of conveyer 606, they are pushed onto conveyer 608 by a linear actuator driven by a solenoid or a pneumatic system. The boxed bun halves move along conveyer 608 and pass beneath the sliced item system 610 to receive the customer's selection of sliced meats or cheeses. Finally, the boxed bun halves move to conveyor 612 (not shown in FIG. 6), again using a solenoid- or pneumatic driven actuator, where they pass under a set of extruded product bins 614. The extruded product bins 614 hold nonsliced sandwich fillers such as pimento cheese spread, tuna salad, chicken salad, or egg salad. The appropriate one or more of these products is dispensed onto the boxed bun halves as they pass under the appropriate extruded product bin, according to the customer's selection. FIG. 6 also shows wash stations 670 below conveyers 606 and 608 and below sliced item system 610. Wash stations 670 are shown and described in FIG. 12 and the associated text below.

FIG. 7 is a perspective view of the upper assembly section 118, shown from the direction opposite that shown in FIG. 6. FIG. 7 shows the boxed bun halves 1000 moving along conveyer 612 under extruded product bins 614. As shown in FIG. 7, after passing under the last of the extruded product bins 614, the boxed bun halves 1000 are removed from conveyer 612 by a robotic elevator mechanism that includes a scoop 618 that moves horizontally along guide rods 616 and vertically along guide rods 620. The scoop 618 slides under the box holding the bun half that now includes the customer's selection of condiments, sliced products, and/or extruded products to remove the box from conveyer 612. The box is then transported by the robotic elevator mechanism in a horizontal direction away from conveyer 612, and then down to the lower assembly section 120. FIG. 12 also shows that conveyer 612 passes through a wash station 670 which is shown in further detail and described below.

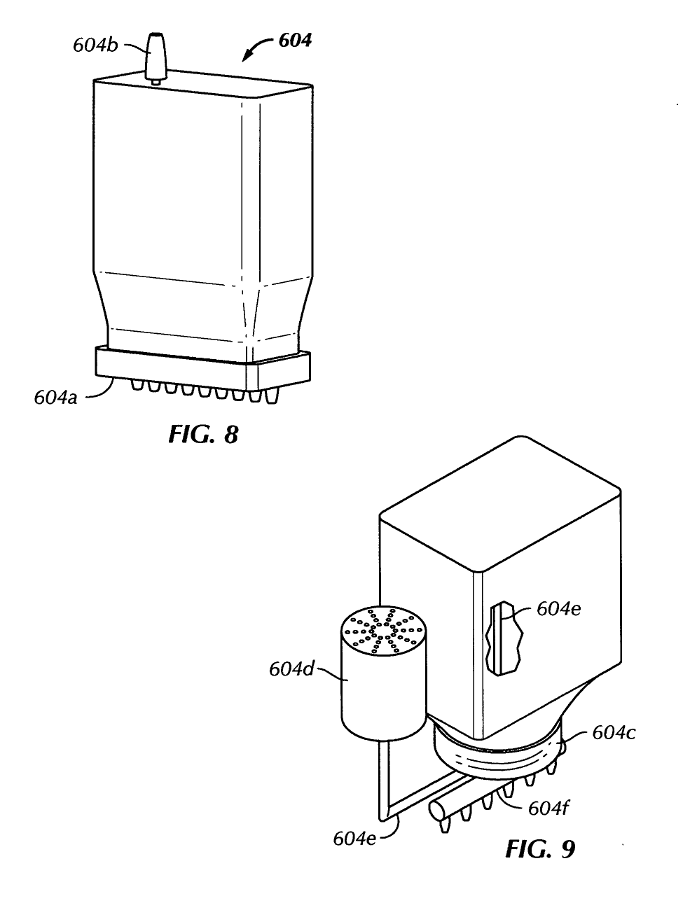

FIG. 8 shows one embodiment of a condiment bin 604 adapted for use in the upper assembly section 118 of the sandwich vending machine 100. In this embodiment, the condiment bin 604 is a molded plastic container with a snap-on lid 604a having a number of dispensing nozzles sized to enable the dispensing of an appropriate amount of condiment when the bin is pressurized by compressed air entering through coupling 604b.

FIG. 9 shows an alternate embodiment of condiment bin 604 adapted for use in the upper assembly section 118 of the sandwich vending machine 100. In this embodiment, a tube 604e extends through the lid 604c and through most of the length of the molded plastic bin. The outer end of the tube 604e is connected to a cylinder and piston assembly 604d, which is driven by a linear actuator. As the piston is forced into the cylinder by the linear actuator, air is injected into the bin, which forces condiment through the manifold nozzles 604f.

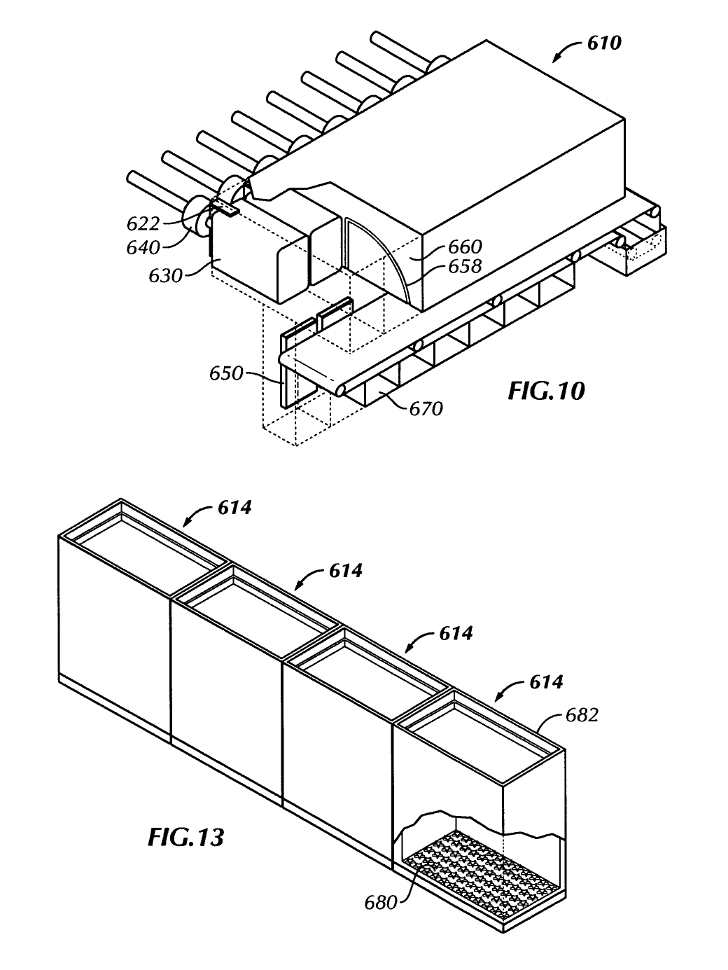

FIG. 10 shows a partial cutaway perspective view of one embodiment of the sliced item station 610. As shown in FIG. 10, the sliced item station 610 includes several sliced item dispensers 622. Each sliced item dispenser 622 includes a container 630 that holds the particular sliced item that that the dispenser 622 dispenses, and is covered by a housing 660. The sliced ingredient (meat or cheese) is pushed through the container 630 by a motor-driven ram 640. The product is pushed out of the container 630 until it is detected by a photosensor (not shown in FIG. 10). When the sliced product is in position, a wedge 650 is raised from its resting position until it has separated the slice(s) from the stack of sliced meat or cheese. The wedge 650 is guided by a set of guide pins 656 (not shown in FIG. 10) that travel in slot 658 in the housing 660. After the tip of the wedge reaches the apex of its travel, the wedge 650 is then rotated about its base into a substantially horizontal position above the conveyor 608. As the boxed bun half passes on the conveyer 608 underneath the horizontal wedge 650, compressed air is blown through the wedge's air channels to separate the slice from the wedge, causing it to fall onto the bun. As shown in FIG. 10, each wedge 650 in the sliced item station 610 includes a wash station 670, and conveyer 608 also passes through a wash station 670. Wash stations are described below in connection with FIG. 12.

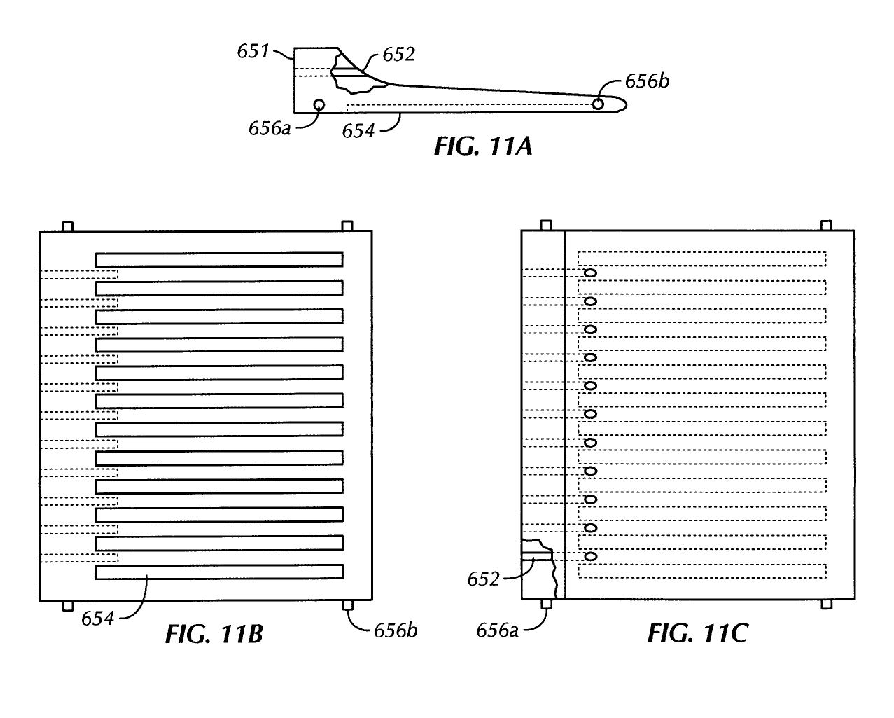

FIGS. 11A, 11B, and 11C show the side view, “stack side” view, and “slice side” view, respectively, of the wedge 650. The “stack side” view, FIG. 11B, shows the surface of the wedge 650 that contacts the stack of sliced products during the operation of the sliced item dispenser 622. The “slice side” view, FIG. 11C, shows the surface of the wedge that contacts the slice that is removed from the product stack and dispensed onto the sandwich during the operation of the sliced item dispenser 622. In a preferred embodiment, the wedge 650 is a plastic or TEFLON-coated metal such as stainless steel or aluminum. The dimensions of the wedge 650 are determined by the size of the ingredient to be manipulated, such that the wedge, when fully raised, completely or substantially separates the ingredient from its stack. As shown in FIG. 11A, the wedge 650 preferably has a rounded tip to “find” the gap between product slices by deforming the slice that it contacts, rather than cutting into it if the registration is not perfect. Alternatively, the tip of the wedge can include a slot that receives a blade, enabling the wedge to be used with unsliced products. In this case, the wedge cuts through the meat or cheese as it rises, to form a slice for the sandwich.

As shown in FIG. 11A, the wedge 650 widens substantially at the base 651, and includes two base guide pins 656a and two tip guide pins 656b. The base includes a number of air channels 652 that terminate on the “slice side.” After the wedge 650 rises, separates the appropriate number of product slices from the product stack, and then rotates about base guide pins 656a to a substantially horizontal position over the boxed bun half, pressurized air is blown through the air channels 652 to separate the product slice(s) from the wedge, such that the slice(s) drop onto the bun half.

FIG. 11B shows that in a preferred embodiment, the “stack side” of the wedge includes a number of shallow channels to minimize the surface area of the wedge in contact with the product stack.

In its preferred embodiment, the wedge is articulated using pneumatic cylinders. Alternately, it can be driven by hydraulics or by linear actuators. As described above in connection with FIG. 10, the tip guide pins 656b that extend from the sides of the wedge at the tip end run in the channel 658 formed in the housing of the sliced item dispenser 622.

FIG. 12 shows a typical conveyer wash station 670, several of which are shown in FIGS. 6, 7, and 10. As shown in FIG. 12, each conveyer is a continuous loop driven by a set of rollers arranged so that the “box side” of the conveyer 672 contacts a rotating brush 676 and a stream of 190° F. water sprayed by sprayers 678. The sliced item dispenser wash stations 670 have a similar configuration, with a rotating brush and a hot water sprayer contacting both the “slice side” and the “stack side” of wedge 650.

FIG. 13 shows a set of extruded product bins 614, one of which is shown as a cutaway view to reveal the perforated bottom 680. As described above, the extruded product bins 614 hold soft sandwich spreads such as pimento cheese or chicken salad. As the boxed bun half passes below the appropriate extruded product bin 614, pressure is applied to the top 682 of the bin 614 via a motor-driven ram to push the product through holes in the perforated bottom 680. The holes in the perforated bottom 680 of a particular extruded product bin 614 are sized to accommodate the consistency variations and viscosity of the particular product being dispensed.

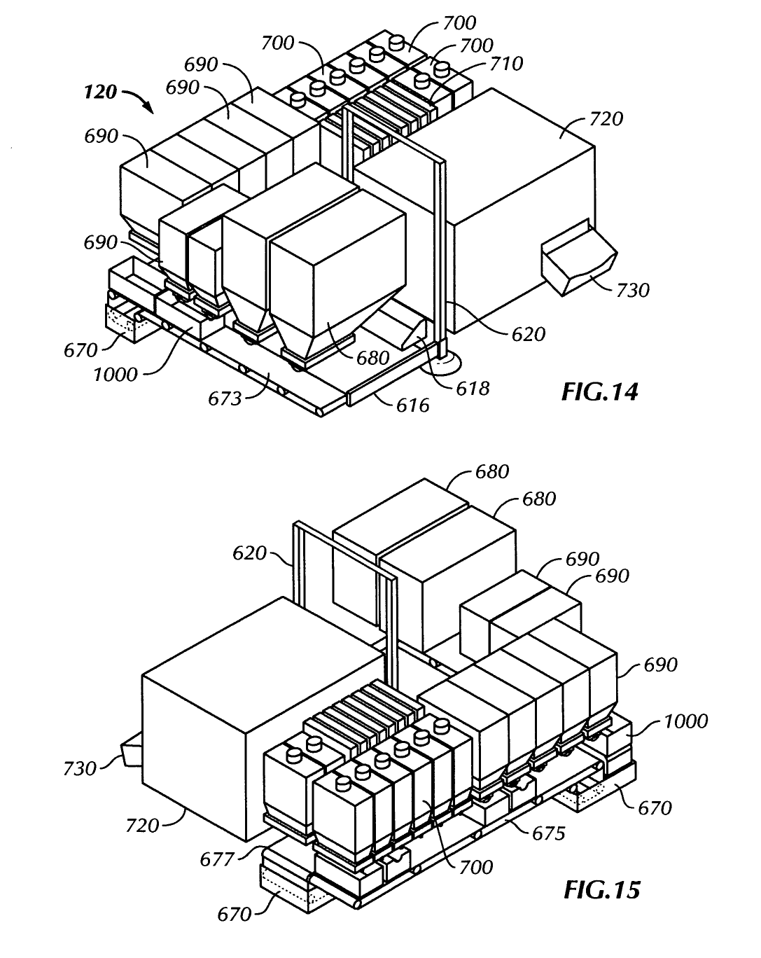

FIG. 14 shows a perspective view of the lower assembly section 120 of the sandwich vending machine 100, according to one embodiment. The lower assembly section 120 includes a number of diced item bins 680 and 690, dressing bins 700, seasoning bins 710, and final packaging and dispensing station 720. The boxed sandwich halves 1000 move through lower assembly section 120 along conveyers 673, 675 (not shown in FIG. 14), and 677 (not shown in FIG. 14). As described above in connection with the upper assembly section 118, each conveyer includes a separate wash station 670.

As shown in FIGS. 7 and 14 and described above, the boxed sandwich halves move from the upper assembly section 118 to the lower assembly section 120 via the scoop 618 that moves horizontally along guide rods 616 and vertically along guide rods 620. The scoop 618 deposits the partially assembled sandwich halves 1000 onto the conveyer 673, whereupon they pass under large diced item bins 680 and small diced item bins 690. Large diced item bins 680 and small diced item bins 690 hold and dispense diced vegetables, which, for the purposes of this specification, are defined as non-meat or non-cheese solid sandwich ingredients, such as tomatoes, pickles, peppers, cucumbers, olives, and various varieties of lettuces and other greens, diced, sliced, shredded, or otherwise cut in any manner to facilitate storage and dispensing. Large diced item bins 680 may hold and dispense bulky and/or more popular sandwich ingredients such as shredded lettuce or diced tomatoes. Small diced item bins 690 may hold and dispense less bulky and/or less popular ingredients, such as sliced or diced pickles, peppers, or olives.

FIG. 15 shows a view of the lower assembly section 120 of the sandwich vending machine 100, from the opposite perspective of that shown in FIG. 14. In this view, conveyers 675 and 677 and their associated wash stations 670 are visible, along with diced item bins 680 and 690, dressing bins 700, seasoning bins 710, and final packaging and dispensing station 720. As shown in FIG. 15, as the boxed sandwich halves 1000 move along conveyer 675, they may receive one or more diced ingredients from bins 690 and one or more dressings such as Italian dressing, ranch dressing, or vinaigrette dressing from dressing bins 700. Thereafter, the boxes move to conveyer 677 via a solenoid or pneumatically driven linear actuator (not shown in FIG. 15) to receive additional dressing selections and/or seasonings from seasoning bins 710.

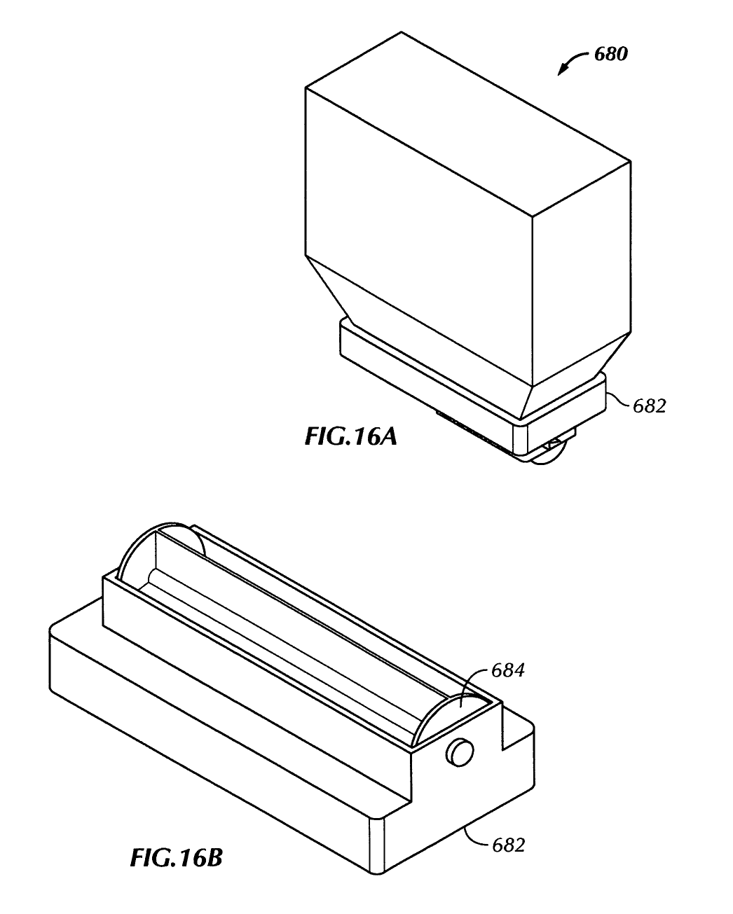

FIG. 16A shows a perspective view of one embodiment of a large diced item bin 680 adapted for use in the lower assembly section 120 of the sandwich vending machine 100. In this embodiment, the diced item bin 680 is a molded plastic container with a snap-on lid 682. As shown in FIG. 16B, snap-on lid 682 includes a rotatable bladed dispensing mechanism 684. As shown in FIG. 14, the large diced item bin 680 is inverted over the conveyer 675. When the sandwich half passes under the diced item bin 680, the dispensing mechanism 684 is rotated by a motor. The blades on the dispensing mechanism capture a quantity of the diced ingredient and deposit that quantity on the sandwich half as they rotate out of the container.

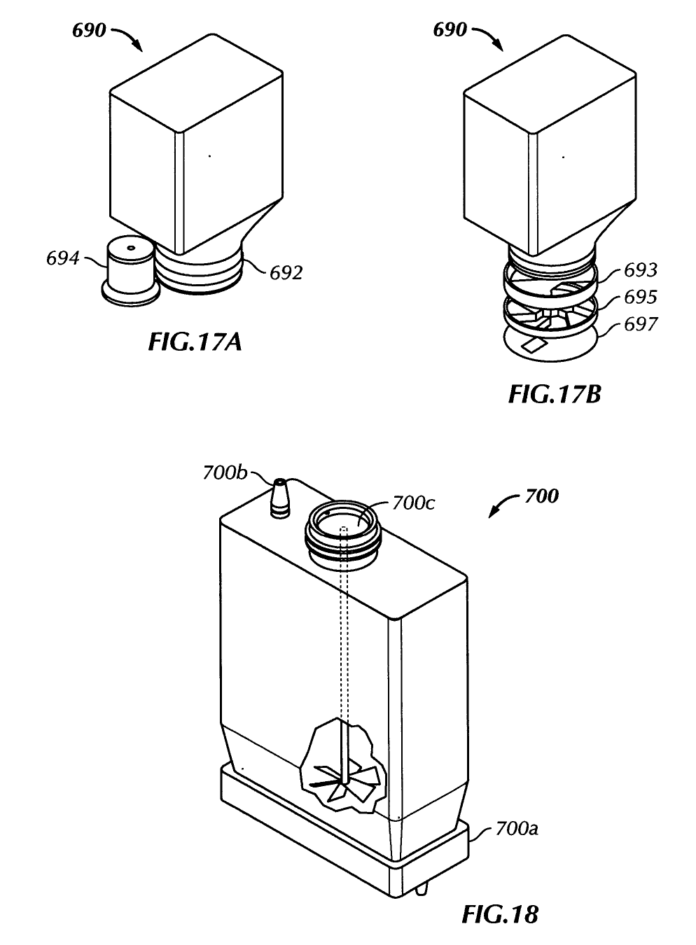

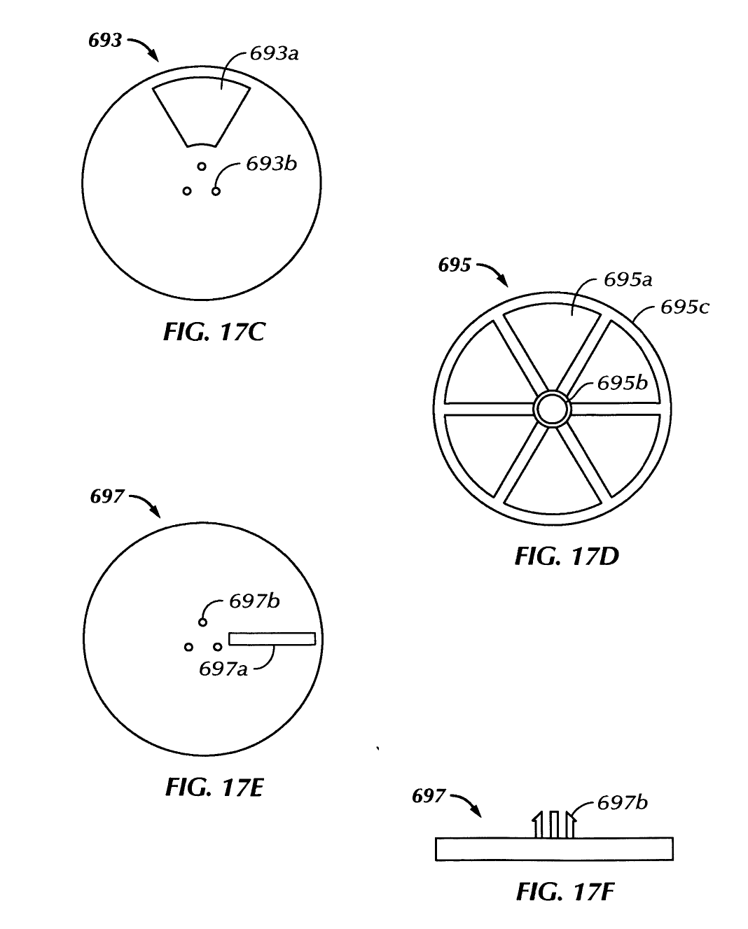

FIG. 17A shows a perspective view of one embodiment of a small diced item bin 690 adapted for use in the lower assembly section 120 of the sandwich vending machine 100. In this embodiment, the small diced item bin 690 is a molded plastic container with a three-piece screw-on lid assembly 692.

As shown in FIGS. 17B through 17F, lid assembly 692 includes fixed outer sections 693 and 697, and rotating middle section 695. Lid section 693, shown in FIG. 17C, screws onto the molded plastic container and includes a nonmoving offset opening 693a and three substantially equidistant through holes 693b. Rotating middle section 695, shown in FIG.17D, is a spoked circle having an inner circumference 695b, six wedge-shaped openings 695a, a selectable thickness, and a rubberized or other high-friction surface 695c around its outer circumference. Fixed outer section 697, shown in FIGS. 17E and 17F, has a through slot 697a and three flanged pins 697b. The lid assembly 692 is assembled by stacking the three pieces 693, 695, and 697 together such that the three flanged pins 697b of fixed outer section 697 extend through the inner circumference 695b of rotating middle section 695 and snap into holes 693b of lid section 693. This enables rotating middle section 695 to rotate around the three flanged pins 697b. The entire assembly is then screwed onto the molded plastic container, which contains sandwich ingredients diced small enough to fit through slot 697a. Small diced item bin 690 is then inverted over the conveyer such that slot 697a extends across the width of the conveyer and the high-friction surface 695c of the rotating middle section 692 of lid assembly 692 contacts the motorized drive wheel 694. When the sandwich half passes under the small diced item bin 690, the rotating middle section 695 is rotated by drive wheel 694. Diced ingredients within the bin fall through offset opening 693a and are captured within the openings 695a of the rotating middle section 695. As each opening 695a rotates past fixed slot 697a, the diced contents within opening 695a fall through slot 697a and are deposited onto the sandwich half.

FIG. 18 shows a cutaway perspective view of one embodiment of a dressing bin 700 adapted for use in the lower assembly section 120 of the sandwich vending machine 100. In this embodiment, the dressing bin 700 is a molded plastic container with a snap-on lid 700a that includes a number of dispensing nozzles sized to enable the dispensing of an appropriate amount of dressing, salsa, or other liquid when the bin is pressurized by compressed air entering through coupling 700b. In addition, the dressing bin 700 may include one or more optional stirrers 700c. As shown in FIG. 18, a stirrer 700c may be a bladed tube extending into the bin 700 which, when either raised and lowered or rotated, stirs the contents of the dressing bin 700.

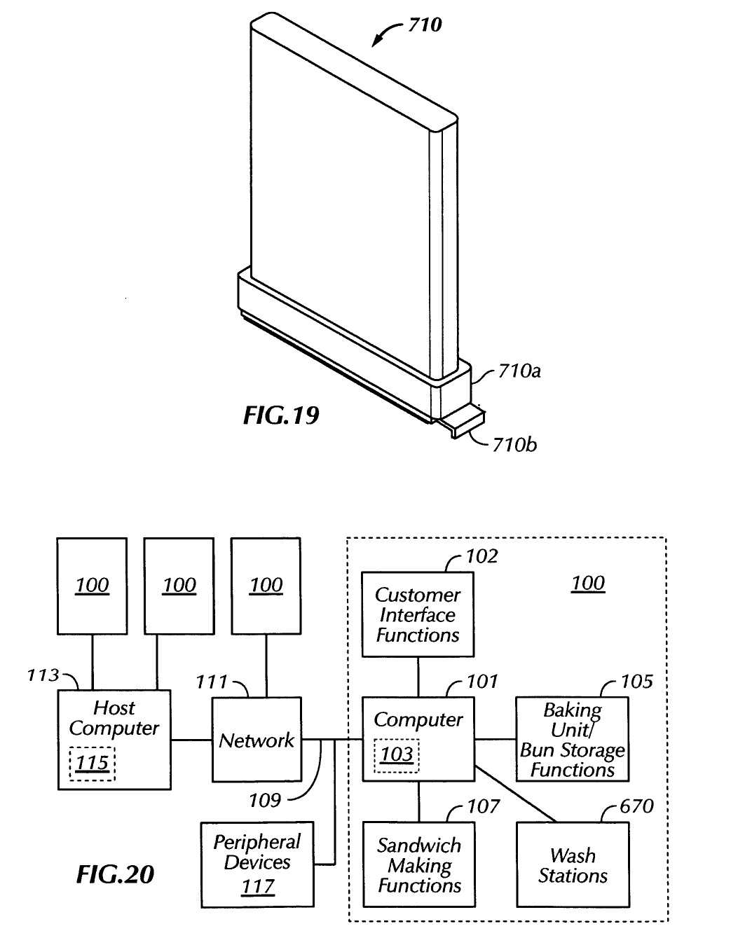

FIG. 19 shows one embodiment of a seasoning bin 710 adapted for use in the lower assembly section 120 of the sandwich vending machine 100. In this embodiment, the seasoning bin 710 is a molded plastic container with a snap-on lid assembly 710a that includes an upper and a lower fixed-position cover (not shown in FIG. 19), each having an array of holes with a specific arrangement. The array in the lower cover is offset from the array in the upper cover, such that the holes do not align. A movable middle cover 710b rests between the upper and lower covers. The movable middle cover 710b has a certain thickness and an array of holes through the thickness in the same arrangement as the array of holes in the upper and lower covers, such that the array forms a set of channels through the thickness of the middle cover 710b. When the channel array in the middle cover is aligned with the hole array in the upper cover, seasonings such as salt, ground black pepper, red pepper flakes, oregano, or other herbs and spices fall from the bin 710 into the channels, where the seasoning is captured within the channels of the middle cover 710b. The channel array in the middle cover is then moved into alignment with the holes in the lower lid, and the captured seasonings fall through the holes in the lower lid onto the sandwich below. The rate of application of seasoning is thus regulated by the speed at which the middle cover is moved back and forth, and the design insures that seasonings are not accidentally dispensed.

Returning to FIG. 15, when the boxes containing the sandwich halves have passed under the seasoning bins 710 on conveyer 677, the boxes move from conveyer 677 to the final packaging and dispensing station 720. In the final packaging and dispensing station 720, the bottom of the box that contains the bottom half of the sandwich is held in place by a gripper that slightly bends in the front and sides. The top half of the box that contains the upper half of the sandwich roll is swung shut in a smooth motion that uses inertia to keep the roll in contact with the box as it closes. In a preferred embodiment, the final packaging and dispensing station 720 includes a printer that prints a label describing the sandwich, which is affixed to the back edge of the box. The closed box is then slid down the product delivery chute 730 to the customer.

FIG. 20 is a block diagram showing the major control functions and interfaces of the submarine sandwich vending machine 100. The submarine sandwich vending machine 100 is controlled by any appropriate programmable electronic controller 101, such as a microprocessor-driven industrial controller or a general purpose computer, that is capable of receiving, reading, and executing software instructions 103 stored in program storage media located either onboard the vending machine or received via network interface 109. The controller 101 and associated software 103 are sufficiently sophisticated to support the above-described customer interaction via the customer interface 102, including the menu-driven CRT, proximity detector, and payment mechanism. In addition, the controller 101 and software 103 control all the bread-baking and bun storage functions 105, including the timing of bun browning cycles and maintenance of appropriate browned bun inventories. The controller 101 and software 103 also control all sandwich-making and delivery functions 107 of the vending machine 100 described above, including selecting the proper browned bun type from the bun bin 506, controlling the timing and operation of conveyers 606, 608, and 612, their associated actuators, and the various ingredient dispensing stations 604, 610, and 614 in the upper assembly section 118, controlling the operation of the scoop 618, and controlling the timing and operation of conveyers 673, 675, and 677, their associated actuators, and the various ingredient dispensing stations 680, 690, 700, and 710 in the lower assembly section 120. The controller 101 and software 103 also control and monitor the operation of each wash station 670. In a preferred embodiment, the programmable controller 101 also includes a wired or wireless network interface 109 that uses either a standard Internet browser, custom software, or both, that enables communication either directly to the Internet or other network 111, to other peripheral devices 117, and/or to and from a host computer 113 having its own supporting software 115. As shown in FIG. 20, the present invention supports a business operation whereby a host computer 113 is capable of controlling and interfacing either directly, or over a network, to a number of machines 100 at various locations. The network interface 109, onboard software 103, host computer 113, and its supporting software 115 allow a user to specify an order for one or more sandwiches. In some embodiments that include a host computer 113 and a number of machines 100 at various locations, the order can be sent to a specific machine, to all of the machines, or to all of the machines previously used by the customer. The sandwiches will not be assembled until the user requests them at one of the machines, but the previous transmission of the order avoids delays due to network congestion or downtime. If the customer attempts to retrieve the order from a machine that has not received the specifications, that machine will request the information from the host computer.

In some embodiments, the onboard software, the host computer software, or both allow the user to specify and name favorite sandwiches, which can be subsequently selected as part of an order. Likewise, the customer can specify a credit card number that can be used for identification at any one of the vending machines. Alternately, the customer can receive an order number from the host computer software, and enter it into a vending machine, which will request the specifications for the order from the host computer. If a large order is placed by a previous customer, the host computer can instruct the relevant machine(s) to increase reserves of baked goods so that the customer's order can be timely retrieved without the need to wait for the completion of one or more baking cycles.

In some embodiments, the onboard software in each machine is capable of reporting ingredient inventories and sales data such as total sales or numbers, types, and times of sandwich sales made to the host computer, which may aggregate that information for all the machines with which it communicates to produce inventory and accounting reports for the business owner. Business owners who operate one or more machines, or who lease machines to others (such as the premises owner) may remotely power up or power down specific machines or include a “keep alive” code that the lessee receives from the business owner under certain business conditions and enters into the machine to keep the machine operable.

The present invention incorporates technology from the following patents: U.S. Pat. No. 6,397,193; U.S. Pat. No. 6,124,800; U.S. Pat. No. 6,119,934; U.S. Pat. No. 6,038,491; U.S. Pat. No. 5,963,452; U.S. Pat. No. 5,503,300; all which are incorporated by reference for all purposes into this specification.

Although the present invention has been described with reference to a specific embodiment of vending machine and specific embodiments of its various components, further modifications and improvements will occur to those skilled in the art, and these modifications do not depart from the present invention. For instance, the depicted embodiment describes a machine that assembles submarine sandwiches using a set of conveyers that transport the sandwich being assembled to the various ingredient dispensing stations. However, the present invention also encompasses an embodiment whereby the ingredient dispensing stations are automatically transported to the sandwich being assembled. Those skilled in the art will recognize that the present invention requires relative motion between the food item being assembled and the ingredient dispensing stations.

In addition, the specifications of the present invention could be easily altered to construct a machine that uses a tortilla or other flat bread product rather than a sub roll, thereby offering wrap sandwiches. Alternatively, such a machine could be altered to offer made-to-order salads, tacos, pastries, or hot sandwiches instead of sub sandwiches. Finally, the machine could include one or more bar code readers or other optical code reading devices adapted to read an encoded “use by” date for each fresh ingredient. The “use by” date could be read and updated as each fresh ingredient is stocked by a service technician. The machine's operating software then monitors the freshness of each ingredient, and removes out-of-date ingredients from the menu option, thereby insuring the quality of the sandwiches the machine produces. Those skilled in the art will understand that the invention disclosed and claimed herein encompasses all such modifications that do not depart from the spirit and scope of the invention as defined in the appended claims.

In sum, the present invention is a vending machine apparatus that automatically assembles a made-to-order food item such as a submarine sandwich, salad, taco, or sandwich wrap in response to a customer order, along with methods for making and using the machine and food item assembly system. The present invention includes a conveyer that produces relative motion between a food item and ingredient dispensing stations that include at least a first, second, and third dispensing station that dispense first, second, and third customer-selected ingredients, respectively. Dispensed ingredients may include one or more condiments, dressings, seasonings, one or more slices of meat, one or more slices of cheese, one or more types of diced vegetables, and one or more soft sandwich spreads. The vending machine may also include an oven that bakes one or more portions of the food item. A computer that controls the conveyer and the ingredient dispensing stations may be included, and the computer may also interface to a network.

Other embodiments of the invention will be apparent to those skilled in the art after considering this specification or practicing the disclosed invention. The specification and examples above are exemplary only, with the true scope of the invention being indicated by the following claims.

I claim the following invention:

1. A vending machine that automatically assembles a food item in response to a customer order, comprising:
a conveyer that produces relative motion between a food item and a plurality of ingredient dispensing stations within the vending machine;
wherein said plurality of ingredient dispensing stations further comprises a first dispensing station that dispenses a customer-selected first ingredient onto the food item;
a second dispensing station that dispenses a customer-selected second ingredient onto the food item; and
a third dispensing station that dispenses a customer-selected third ingredient onto the food item.

2. The vending machine of claim 1, wherein said food item is a sandwich, and wherein said first ingredient, said second ingredient, and said third ingredient each comprise one of the following: a condiment, one or more slices of meat, one or more slices of cheese, a diced vegetable, or a soft sandwich spread.

3. The vending machine of claim 1, further comprising an oven that bakes one or more portions of said food item.

4. The vending machine of claim 1, further comprising a computer that controls said conveyer and said plurality of ingredient dispensing stations.

5. The vending machine of claim 4, wherein said computer interfaces to a network.

6. An automatic food assembly system that assembles a food item in response to a customer order, comprising:
a conveyer that produces relative motion between a food item and a plurality of ingredient dispensing stations within the system;
wherein said plurality of ingredient dispensing stations further comprises a first dispensing station that dispenses a customer-selected first ingredient onto the food item;
a second dispensing station that dispenses a customer-selected second ingredient onto the food item; and
a third dispensing station that dispenses a customer-selected third ingredient onto the food item.

7. The system of claim 6, wherein said food item is a sandwich, and wherein said first ingredient, said second ingredient, and said third ingredient each comprise one of the following: a condiment, one or more slices of meat, one or more slices of cheese, a diced vegetable, or a soft sandwich spread.

8. The system of claim 6, further comprising an oven that bakes one or more portions of said food item.

9. The system of claim 6, further comprising a computer that controls said conveyer and said plurality of ingredient dispensing stations.

10. The system of claim 9, wherein said computer interfaces to a network.

11. A method to manufacture a vending machine that assembles a food item in response to a customer order, comprising:
providing a plurality of ingredient dispensing stations; and
providing a conveyer that produces relative motion between a food item and said plurality of ingredient dispensing stations;
wherein said plurality of ingredient dispensing stations further comprises a first dispensing station that dispenses a customer-selected first ingredient onto the food item;
a second dispensing station that dispenses a customer-selected second ingredient onto the food item; and
a third dispensing station that dispenses a customer-selected third ingredient onto the food item.

12. The method of claim 11, wherein said food item is a sandwich, and wherein said first ingredient, said second ingredient, and said third ingredient each comprise one of the following: a condiment, one or more slices of meat, one or more slices of cheese, a diced vegetable, or a soft sandwich spread.

13. The method of claim 11, further comprising providing an oven that bakes one or more portions of said food item.

14. The method of claim 11, further comprising providing a computer that controls said conveyer and said plurality of ingredient dispensing stations.

15. The method of claim 14, wherein said computer interfaces to a network.

16. A method that uses a vending machine that assembles a food item in response to a customer order, comprising:
producing relative motion between a food item and a plurality of ingredient dispensing stations using a conveyer;
dispensing a customer-selected first ingredient onto the food item using a first dispensing station within said plurality of ingredient dispensing stations;
dispensing a customer-selected second ingredient onto the food item using a second dispensing station within said plurality of ingredient dispensing stations; and
dispensing a customer-selected third ingredient onto the food item using a third dispensing station within said plurality of ingredient dispensing stations.

17. The method of claim 16, wherein said food item is a sandwich, and wherein said first ingredient, said second ingredient, and said third ingredient each comprise one of the following: a condiment, one or more slices of meat, one or more slices of cheese, a diced vegetable, or a soft sandwich spread.

18. The method of claim 16, further comprising using an oven to bake one or more portions of said food item.

19. The method of claim 16, further comprising controlling said conveyer and said plurality of ingredient dispensing stations using a computer.

20. The method of claim 19, wherein said computer interfaces to a network.

21. A program storage device readable by a computer that tangibly embodies a program of instructions executable by the computer to perform a method that uses a vending machine that assembles a food item in response to a customer order, said method comprising:
producing relative motion between a food item and a plurality of ingredient dispensing stations using a conveyer;
dispensing a customer-selected first ingredient onto the food item using a first dispensing station within said plurality of ingredient dispensing stations;
dispensing a customer-selected second ingredient onto the food item using a second dispensing station within said plurality of ingredient dispensing stations; and
dispensing a customer-selected third ingredient onto the food item using a third dispensing station within said plurality of ingredient dispensing stations.

22. The program storage device of claim 21, wherein said food item is a sandwich, and wherein said first ingredient, said second ingredient, and said third ingredient each comprise one of the following: a condiment, one or more slices of meat, one or more slices of cheese, a diced vegetable, or a soft sandwich spread.

23. The program storage device of claim 21, wherein said method further comprises using an oven to bake one or more portions of said food item.

24. The program storage device of claim 21, wherein said computer interfaces to a network.

25. A vending machine that automatically assembles a food item in response to a customer order, comprising:
a conveyer that produces relative motion between a food item and a plurality of ingredient dispensing stations within the vending machine;
a computer that controls said conveyer and said plurality of ingredient dispensing stations, said computer has a network interface;
an oven that bakes one or more portions of said food item;
wherein said plurality of ingredient dispensing stations further comprises a first dispensing station that dispenses a customer-selected first ingredient onto the food item;
a second dispensing station that dispenses a customer-selected second ingredient onto the food item; and
a third dispensing station that dispenses a customer-selected third ingredient onto the food item; and
wherein said food item is a sandwich, and wherein said first ingredient, said second ingredient, and said third ingredient each comprise one of the following: a condiment, one or more slices of meat, one or more slices of cheese, a diced vegetable, or a soft sandwich spread.

26. An automatic food assembly system that assembles a food item in response to a customer order, comprising:
a conveyer that produces relative motion between a food item and a plurality of ingredient dispensing stations within the system;
a computer that controls said conveyer and said plurality of ingredient dispensing stations, said computer has a network interface;
an oven that bakes one or more portions of said food item;
wherein said plurality of ingredient dispensing stations further comprises a first dispensing station that dispenses a customer-selected first ingredient onto the food item;
a second dispensing station that dispenses a customer-selected second ingredient onto the food item; and
a third dispensing station that dispenses a customer-selected third ingredient onto the food item; and
wherein said food item is a sandwich, and wherein said first ingredient, said second ingredient, and said third ingredient each comprise one of the following: a condiment, one or more slices of meat, one or more slices of cheese, a diced vegetable, or a soft sandwich spread.

27. A method to manufacture a vending machine that assembles a food item in response to a customer order, comprising:
providing a conveyer that produces relative motion between a food item and a plurality of ingredient dispensing stations within the vending machine;
providing a computer that controls said conveyer and said plurality of ingredient dispensing stations, said computer has a network interface;
providing an oven that bakes one or more portions of said food item;
wherein said plurality of ingredient dispensing stations further comprises a first dispensing station that dispenses a customer-selected first ingredient onto the food item;
a second dispensing station that dispenses a customer-selected second ingredient onto the food item; and
a third dispensing station that dispenses a customer-selected third ingredient onto the food item; and
wherein said food item is a sandwich, and wherein said first ingredient, said second ingredient, and said third ingredient each comprise one of the following: a condiment, one or more slices of meat, one or more slices of cheese, a diced vegetable, or a soft sandwich spread.

28. A method that uses a vending machine that assembles a food item in response to a customer order, comprising:
producing relative motion between a food item and a plurality of ingredient dispensing stations within the vending machine using a conveyer;
controlling said conveyer and said plurality of ingredient dispensing stations using a computer having a network interface; and
baking one or more portions of said food item using an oven;
wherein said plurality of ingredient dispensing stations further comprises a first dispensing station that dispenses a customer-selected first ingredient onto the food item;
a second dispensing station that dispenses a customer-selected second ingredient onto the food item; and
a third dispensing station that dispenses a customer-selected third ingredient onto the food item; and
wherein said food item is a sandwich, and wherein said first ingredient, said second ingredient, and said third ingredient each comprise one of the following: a condiment, one or more slices of meat, one or more slices of cheese, a diced vegetable, or a soft sandwich spread.

29. A program storage device readable by a computer that tangibly embodies a program of instructions executable by the computer to perform a method that uses a vending machine that assembles a food item in response to a customer order, said method comprising:
producing relative motion between a food item and a plurality of ingredient dispensing stations within the vending machine using a conveyer;
controlling said conveyer and said plurality of ingredient dispensing stations using a computer having a network interface; and
baking one or more portions of said food item using an oven;
wherein said plurality of ingredient dispensing stations further comprises a first dispensing station that dispenses a customer-selected first ingredient onto the food item;
a second dispensing station that dispenses a customer-selected second ingredient onto the food item; and
a third dispensing station that dispenses a customer-selected third ingredient onto the food item; and
wherein said food item is a sandwich, and wherein said first ingredient, said second ingredient, and said third ingredient each comprise one of the following: a condiment, one or more slices of meat, one or more slices of cheese, a diced vegetable, or a soft sandwich spread.
